(19) United States
(12) Patent Application Publication
(10) Pub. No.: US 2013/0144658 A1
(43) Pub. Date: Jun. 6, 2013

(54) System and Method for Bundling of Homeowner Insurance and a Home Service Contract

(71) Applicant: CROSS COUNTRY HOME SERVICES, INC., Sunrise, FL (US)

(72) Inventors: Gary M. Schnabolk, Parkland, FL (US); Ori Lapidot, Parkland, FL (US); Jay Darfler, Fort Lauderdale, FL (US)

(73) Assignee: CROSS COUNTRY HOME SERVICES, INC., Sunrise, FL (US)

(21) Appl. No.: 13/692,341

(22) Filed: Dec. 3, 2012

Related U.S. Application Data
(60) Provisional application No. 61/565,618, filed on Dec. 1, 2011.

(51) Int. Cl. G06Q 40/08

(52) U.S. Cl. CPC G06Q 40/08
USPC 705/4

(57) ABSTRACT

A method for bundling homeowner insurance and a home service contract includes providing a homeowner insurance policy on at least one property owned by a homeowner, and determining at least one home service contract based upon the at least one property owned by the homeowner. The home service contract includes preventative maintenance on the property. The method also includes calculating an insurance premium savings for the home service contract(s), providing the homeowner with an opportunity to purchase at least one of the home service contracts, and bundling the homeowner insurance policy with the home service contract purchased by the homeowner.

### PRIORITY

This patent application claims priority from U.S. Provisional Patent Application No. 61/565,618, filed Dec. 1, 2011, entitled, “System and Method for Bundling of Homeowner Insurance and a Home Service Contract,” and naming Gary M. Schnabolk and Ori Lapidot as inventors, the disclosure of which is incorporated herein, in its entirety, by reference.

### TECHNICAL FIELD

The present invention generally relates to home service contracts, and more particularly to bundling homeowner insurance with home service contracts.

### BACKGROUND ART

Most homeowners purchase homeowner insurance to protect themselves in the event of damage to their home. For example, as is known in the art, homeowner insurance can provide the homeowner with financial protection against fire, flood, storm, and other damage to their homes. Additionally, if the homeowner has a mortgage on the home, most mortgage lenders require the homeowner to carry insurance for the length of the mortgage.

As one may expect, the cost of the homeowner insurance (e.g., the insurance premium) is dependent upon a number of factors including the estimated value of the home, the location of the home (e.g., the part of the country, whether the home is in a flood plain, etc.), and the risk of claims being made. Some of the most common claims made by homeowners are caused by the failure of common items within the home and could have prevented by regular maintenance of the items.

### SUMMARY OF THE EMBODIMENTS

In accordance with some embodiments of the present invention, a system for bundling homeowner insurance and a home service contract includes a processor and memory. The memory may store instructions executable by the processor to perform processes that include (1) providing, to a homeowner, a homeowner insurance policy on at least one property owned by the homeowner, (2) determining at least one home service contract based upon the at least one property owned by the homeowner, (3) calculating an insurance premium savings for each of the at least one home service contracts, (4) offering the at least one home service contract to the homeowner, and (5) bundling the homeowner insurance policy with the purchased home service contract (if the homeowner purchases one of the at least one home service contacts). The home service contract may include preventative maintenance on one or more high risk home items.

The preventative maintenance on the one or more high risk items may reduce the risk of damage to the home, thereby reducing insurance claims. The insurance premium savings may be based, at least in part, upon the reduction in the risk of insurance claims. The preventative maintenance may include replacing water hoses on a clothes washer (e.g., with stainless steel water hoses) and/or cleaning a vent on a clothes dryer.

The home service contract may not cover missing appliances, missing home systems, rust and corrosion, and abuse to the property. Abuse to the property may include intentional or neglectful damage to air conditioning systems, heating systems, kitchen appliances, and/or laundry appliances. The home service contract may be a multi-year service contract. Bundling the home service contract and the homeowner insurance policy may include applying the insurance premium savings for the home service contract purchased by the homeowner to a cost of the insurance.

In accordance with additional embodiments of the present invention a computer implemented method for bundling homeowner insurance and a home service contract may include providing, using a computer, a homeowner insurance policy on at least one property owned by a homeowner, and determining, using a computer, at least one home service contract based upon the at least one property owned by the homeowner. The home service contract may include at least one preventative maintenance service on the property. The computer implemented method may also include (1) calculating, using a computer, an insurance premium savings for each of the at least one home service contracts, (2) providing, using a computer, the homeowner with an opportunity to purchase at least one of the home service contracts, and (3) bundling, using a computer, the homeowner insurance policy with the home service contract purchased by the homeowner. Bundling the insurance and the home service contract may include applying the insurance premium savings for the home service contract to a cost of the insurance policy.

The at least one preventative maintenance service may be performed on one or more high risk home items, and may reduce the risk of damage to the home. Reducing the risk of damage to the home may, in turn, reduce the risk of insurance claims by the homeowner. The insurance premium savings may be based, at least in part, upon the reduction in the risk of insurance claims.

The preventative maintenance service(s) may include replacing water hoses on a clothes washer and/or cleaning a vent on a clothes dryer. For example, the water hoses may be replaced with stainless steel water hoses. In some embodiments, the home service contract does not cover missing appliances, missing home systems, rust and corrosion, and abuse to the property. Abuse to the property may include intentional or neglectful damage to air conditioning systems, heating systems, kitchen appliances, and laundry appliances. The home service contract may be a multi-year service contract.

In accordance with further embodiments, a system for bundling homeowner insurance and a home service contract may include means for providing a homeowner insurance policy on at least one property owned by a homeowner, and means for determining at least one home service contract based upon the at least one property owned by the homeowner. The home service contract may include at least one preventative maintenance service on the property. The system may also include (1) means for calculating an insurance premium savings for each of the at least one home service contracts, (2) means for providing the homeowner with an opportunity to purchase at least one of the home service contracts, and (3) means for bundling the homeowner insurance policy with the home service contract purchased by the homeowner. Bundling may include applying the insurance premium savings for the home service contract purchased by the homeowner to a cost of the insurance policy.

The preventative maintenance service may be performed on one or more high risk home items to reduce the risk of damage to the home and reduce the risk of insurance claims by the homeowner. The insurance premium savings may be based, at least in part, upon the reduction in the risk of insurance claims. The at least one preventative maintenance service may include replacing water hoses on a clothes washer (e.g., with stainless steel hoses) and/or cleaning a vent on a clothes dryer. The home service contract may not cover missing appliances, missing home systems, rust and corrosion, and abuse to the property (e.g., intentional or neglectful damage to at least one air conditioning systems, heating systems, kitchen appliances, and laundry appliances). The home service contract may be a multi-year service contract.

In accordance with additional embodiments, a system for calculating discounts for an insurance policy bundled with a home service contract may include a processor and a memory. The memory may store instructions executable by the processor to perform processes that include (1) providing a home owner with a home service contract for at least one property owned by the home owner, (2) notifying an insurance provider that the home owner has purchased the home service contract, (3) calculating an initial insurance premium discount package based upon the home service contract purchased by the home owner, and (4) providing the insurance provider access to a dynamic pricing system. The dynamic pricing system may include the initial insurance premium discount package for the homeowner insurance policy, and allow the insurance provider to provide an initial insurance premium discount to the home owner. The home service contract may include preventative maintenance on one or more high risk home items.

The processes may also include receiving service contract claims data and household data, and storing the data in a claims history database and a household environment database. The service contract claims data may include data relating to home service contract claims made by the homeowner, and the household data may include data relating to a plurality of items (e.g., make, model, age, condition, etc.) within the home.

Additionally, the processor may also perform a first trend analysis on the claims data and household data to determine a risk level to the insurance provider.

The system may also receive insurance claim data from the insurance provider, store the insurance claim data within a pricing database, and perform a second trend analysis on the insurance claim data, service contract claims data, and household data to determine a level of insurance claim mitigation for the homeowner. Based upon the level of insurance claim mitigation, the system can also develop an enhanced insurance premium discount package, and provide the insurance company access to the dynamic pricing system (which includes the enhanced insurance premium discount package). The insurance provider may then provide an enhanced insurance premium discount to the home owner. The system can also provide the insurance provider access to the service contract claims data, the household data, and the first and second trend analysis.

### BRIEF DESCRIPTION OF THE DRAWINGS

The foregoing features of embodiments will be more readily understood by reference to the following detailed description, taken with reference to the accompanying drawings, in which:

FIG. 1 shows a flowchart showing the steps of one method for bundling a home service contract with a homeowner's insurance policy, in accordance with some embodiments of the present invention.

FIG. 2 schematically shows a system for bundling a home service contract with a homeowner's insurance policy, in accordance with various embodiments of the present invention.

FIG. 3 schematically shows a block diagram of a computerized method for bundling a home service contract and a homeowner's insurance policy, in accordance with an embodiment of the present invention.

FIG. 4 schematically shows an alternative embodiment of a system for bundling a home service contract and a homeowner's insurance policy, in accordance with an embodiment of the present invention.

FIG. 5 shows a process flowchart of a method for determining dynamic pricing discounts for a homeowner insurance policy bundled with a home service contract, in accordance with some embodiments of the present invention.

FIG. 6 schematically shows a system for determining dynamic pricing discounts for a homeowner insurance policy bundled with a home service contract, in accordance with an embodiment of the present invention.

### DETAILED DESCRIPTION OF SPECIFIC EMBODIMENTS

Various embodiments of the present invention provide systems and methods for bundling a home service contract with homeowner's insurance. Specific embodiments offer a home service contract to the homeowner purchasing the insurance policy, and perform various maintenance and/or home services that increase home safety. Details of illustrative embodiments are discussed below.

The described embodiments of the invention are intended to be merely exemplary and numerous variations and modifications will be apparent to those skilled in the art. All such variations and modifications are intended to be within the scope of the present invention as defined in the appended claims. For example, the term “home service contract” should be interpreted expansively to also include line protection programs that cover delivery of one or more utilities to the home. Additionally, the term “home service contract” may include protection programs for all or part of the home. For example, the home service contract may only protect items (e.g., appliances and systems) within the kitchen (e.g., a kitchen protection plan) or may only protect home appliances (e.g., an appliance protection program).

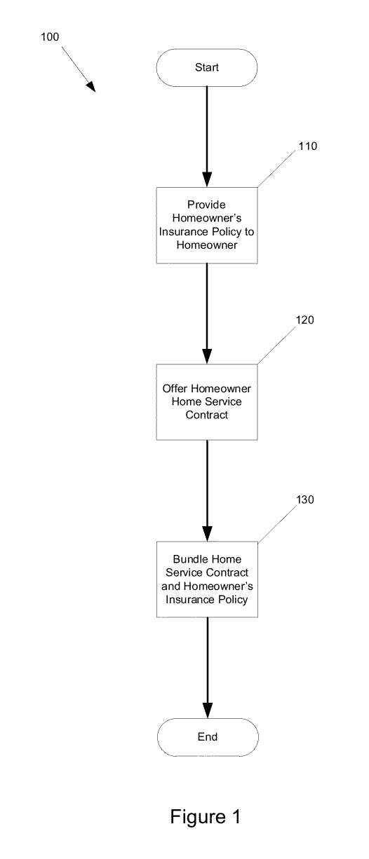

FIG. 1 shows one embodiment of a method in accordance with the present invention. According to the method 100, an insurance company can provide the homeowner with a homeowner's insurance policy (Step 110). During the purchasing of the insurance policy, the method 100 may offer the homeowner a service contract on their property or properties (Step 120). It is important to note that, although a homeowner is discussed above and throughout the present application, the insurance company and/or home service contract company may provide similar warranties to other individuals or entities (e.g., a home renter/rental property). For example, the insurance provider and/or home service contract provider may provide the insurance policy and/or service contract to (e.g., it may be purchased by) a renter, an individual purchasing a new home (e.g., someone who is not the owner at the time of purchasing the insurance policy), or a mortgage lender purchasing the policy on behalf of the homeowner or home purchaser.

The service contract can be for a variety of terms (e.g. six months, one year, two years, three years, etc.) and may cover a variety of the systems and appliances of the home. For example, the service contract may cover anything that goes wrong with the electrical and/or plumbing in the home. Additionally, the service contract may also be structured such that it does not cover other aspects of the home. For example, the service contract can be structured such that it does not cover missing appliances and systems (e.g., refrigerator, stove, A/C system), rust, corrosion, and intentional or negligent abuse (e.g., to air conditioning and heating systems, kitchen and laundry appliances, etc.).

In some embodiments, the home service contract may include preventative maintenance on one or more home systems, components, and/or items that are considered to be high-risk (e.g., those components that are considered as having a high risk of failure and/or are known for causing large amounts of damage if not maintained properly). For example, the water hoses connected to laundry machines are known to break and cause significant flood damage. Similarly, lint traps and vents in clothes dryers can cause a fire if they are not regularly cleaned. To that end, the home service contract may include replacement of the washer hoses and cleaning of the lint trap and vent of the clothes dryer. In some embodiments, the hoses may be replaced with high quality hoses (e.g., stainless steel hoses) to further reduce the risk of failure and flood damage. Furthermore, the preventative maintenance may occur only once (e.g., at the beginning of the service contract) or it may occur regularly (e.g., annual cleaning of the dryer vent, replacement of the hoses every few years, etc.).

It is important to note that some components within the home (e.g., water heaters) may not be serviceable. Therefore, for such components, the technician may simply take note of the condition of the component (e.g., if it is in poor condition and is about to fail). Additionally, during the maintenance visits, the technician may collect data regarding the various components within the home and the home itself. For example, the technician can collect data regarding the make, model, age, and condition of the various appliances within the home, any air conditioning units, the furnace, etc. Additionally, the technician may also collect additional data regarding the condition of structural elements of the home, and demographic data regarding the location of the home and the home owners. As discussed in greater detail below, the information collected by the technician may be used to determine additional discounts and pricing moving forward (e.g., dynamic pricing).

If the homeowner/insurance policy purchaser decides to purchase the home service contract, the method may then bundle the home service contract and the insurance policy (Step 130). As mentioned above, the home service contract may include specific maintenance for the home's laundry appliances (or other high risk items). By including this specific maintenance, some of the leading causes of fire and flood damage are addressed which results in a lower risk of damage to the home and claims by the homeowner. This reduction in risk and the bundling of the insurance policy with the home service contract can act to lower the insurance premiums for the homeowner (e.g., because a lower risk of claims means a lower insurance premium).

Many prospective home service contract purchasers and holders may have reservations regarding the purchase of a home service contract, despite the benefits that a home service contract provides. For example, a purchaser may be concerned that they will never need the service contract (e.g., they will not have to make a claim) and, therefore, will not receive enough value/benefit from the service contract. However, because the home service contract and the specific maintenance that it provides reduces the cost of the insurance policy, at least a portion of the cost of the home service contract is offset, thus increasing the benefit to the purchaser and increasing the likelihood that the insurance policy purchaser will also purchase the home service contract.

In some embodiments, the homeowner/insurance purchaser can be billed for both the home service contract and the insurance premium at the same time (e.g., they can be billed a single amount for both the home service contract and the insurance premium). In alternative embodiments, the homeowner/insurance purchaser can be billed separately for the home service contract and the insurance premium.

Additionally, the home service contract provider may be billed directly and/or directly pay for the preventative maintenance (e.g., the replacement of washer hoses and the cleaning of the dryer vents). For example, the technician conducting the maintenance visit may directly bill the home service contract provider for the visit, and the home service contract provider may then directly pay the technician for the visit. In other embodiments, the technician may bill the contract holder (e.g., the homeowner) and the contract holder may then pay for the maintenance visit. The contract holder may then contact the home service contract provider (e.g., by submitting a receipt) in order to receive a full or partial reimbursement (if the maintenance visit included maintenance beyond the scope of the home service contract) of the cost of the maintenance visit.

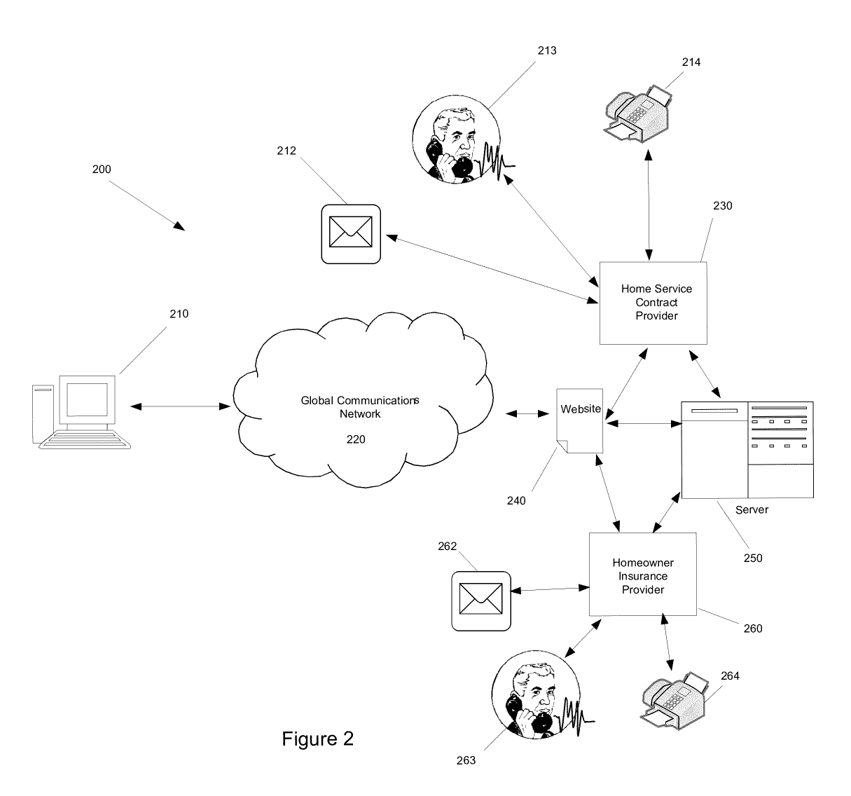

As mentioned above and as shown in FIG. 2, some embodiments of the present invention may be implemented as home service contract and homeowner insurance bundling system 200. For example, the system 200 may include a global data communications network 220, such as the internet. The system 200 may also include a server 250 that is in communication with the global communications network 220 and supports a website 240. The website 240 may consist of a plurality of web pages. The system 200 may also include one or more customer terminals 210 such as workstations within the purchasers home (e.g., if the homeowner is purchasing the insurance and service contract), banks, mortgage lenders, or real estate agency (e.g., those institutions that may be purchasing the insurance on behalf of the homeowner). Additionally or alternatively, the terminals 210 may be workstations within other representatives of the homeowner and/or insurance purchaser, or a third party that may be selling the home service contracts.

The customer terminals 210 may be in communication with the global communications network 220 to allow the customer terminals 210 and the insurance purchaser to access the website 240 (e.g., to purchase the insurance and/or home service contract). For example, the website 240 may be accessed and displayed by the workstations 210 over the global communications network 220. Further, the workstations 210 may send information back to the server 250 over the global communications network 220.

Besides communications by workstations 210 over the global communications network 220, embodiments of the present invention may also support other communications methods such as by mail 212/262, phone calls 213/263, and/or fax 214/264. Communications such as mail 212/262, phone 213/263, and fax 214/264 allow insurance and contract purchasers and/or third parties to contact a representative of the home service contract provider and/or homeowner insurance provider to place their order. The representative may then input the necessary information into the system 200 described below and complete the transaction.

As mentioned above, the system 200 may also include the home service contract provider 230 and the homeowner insurance provider 260. Both the home service contract provider 230 and the homeowner insurance provider 260 may access and view the website 240 and access any data stored within the server 250. The home service contract provider 230 and the homeowner insurance provider 260 may also send information back to the server 250 (e.g., over the global communications network 220).

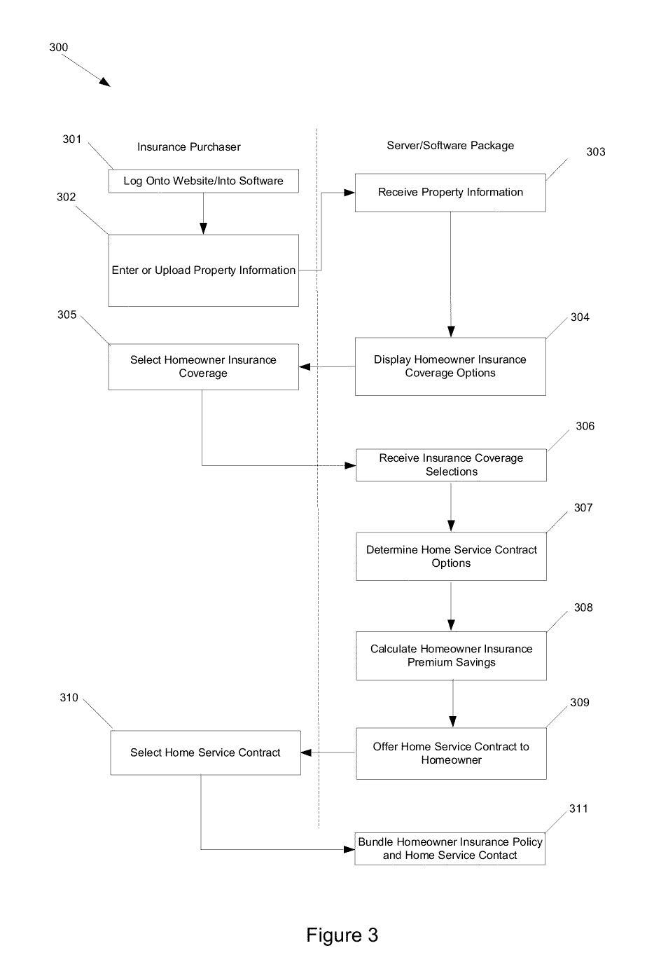

FIG. 3 shows a computerized method 300 for bundling a home service contract with a homeowner insurance policy in accordance with some embodiments of the present invention. As shown in FIG. 3, a user (e.g., the insurance policy purchaser) may log onto the website 240 or software package (Step 301), for example, using one of the workstations 210 shown in FIG. 2. Once logged-in, the user may input or upload information regarding the property for which they wish to obtain an insurance policy (Step 302). For example, the user may manually input (e.g., by typing) the information regarding the property (e.g., address, condition and age of property, value of home, desired level of insurance coverage, deductible information etc.) or the user may upload the information (e.g., from a hard-drive, other memory on the workstation 210, or from an external memory device). In some embodiments, the property information may have been pre-established such as by data (e.g., in a batch file) from a third party such as a real estate agent, mortgage lender, or telemarketing organization.

Once the property information is entered/uploaded, the server 250 or the software package may receive the property information (Step 303), and generate and/or display a list of insurance coverage options (e.g., amount of coverage, insurance company, amount of deductible, policy terms, etc.) (Step 304) for the property (e.g., based upon the received information). The user may then select the insurance policy and terms (e.g., the homeowner insurance coverage) that they wish to purchase for the property (Step 305).

Upon receipt of the homeowner insurance coverage selections (Step 306), the system 300 may determine a number of home service contract options for the insurance policy purchaser (Step 307). In some embodiments, the cost of the service contract may not be dependent upon the individual home and the characteristics (e.g., age and condition) of the home and home systems/appliances. Therefore, in such embodiments, much of the inputted/uploaded information may be for informational purposes only. Additionally or alternatively, the information may be used by technicians when responding to a maintenance call (e.g., so they know which tools and/or parts may be needed) or by the home service contract provider when determining whether a component, appliance, piece of equipment, or home system should be replaced or repaired. The home service contract options may include a list of items that can be covered, the term of the service contract, deductible options (e.g., how much of a deductible the user would like), upgrade options, etc.

In alternative embodiments, the server/software package may generate a list of standard (e.g., non-customizable) service contract packages that contain standard coverage. Or rather than one or more service contract packages as such, there may be a base coverage option and one or more optional coverage upgrades. For example, the server/software package may also generate additional coverage options for some of the unique appliances and systems that the property may contain (e.g., pool pumps and equipment, sump pumps, second refrigerator, second air conditioning units, etc.). If the service contracts are being sold by third party marketers (e.g., third party direct marketers or third party telemarketers), the service contracts generated/determined may be a specific service contract with only limited variation.

As mentioned above, because the home service contracts include preventative maintenance on and replacement of some high-risk items within the home (thereby reducing the risk of claims by the homeowner), some embodiments of the present invention can reduce the insurance premiums for the homeowner. To that end, the server/software package 300 can calculate the savings based upon the selected insurance coverage and each of the home service contract options (Step 308). The server/software package 300 may then offer the home service contracts to the homeowner (Step 309).

When offering the home service contracts to the homeowner (or other purchaser), the server/software package 300 can simply list the home service contract options. Alternatively, the server/software package 300 can list the home service contract options along with the estimated insurance premium savings for each home service contract (e.g., from Step 308) so that the purchaser can better decide the home service contract that is best for them.

Once presented with the home service contract options, the homeowner/policy purchaser can then select the their desired home service contract (Step 310), and the server/software package 300 can then bundle the homeowner insurance policy and the home service contract (Step 311). When the home service contract is bundled with the homeowner insurance, the server/software package 300 can apply the insurance premium saving to the cost of the insurance policy. Additionally, sometime after the home service contract and the insurance policy are purchased and bundle, the home service contract provider (or the homeowner) can arrange for the specific maintenance discussed above to be performed (e.g., the preventative maintenance to replace the washer hoses and clean out the dryer vents).

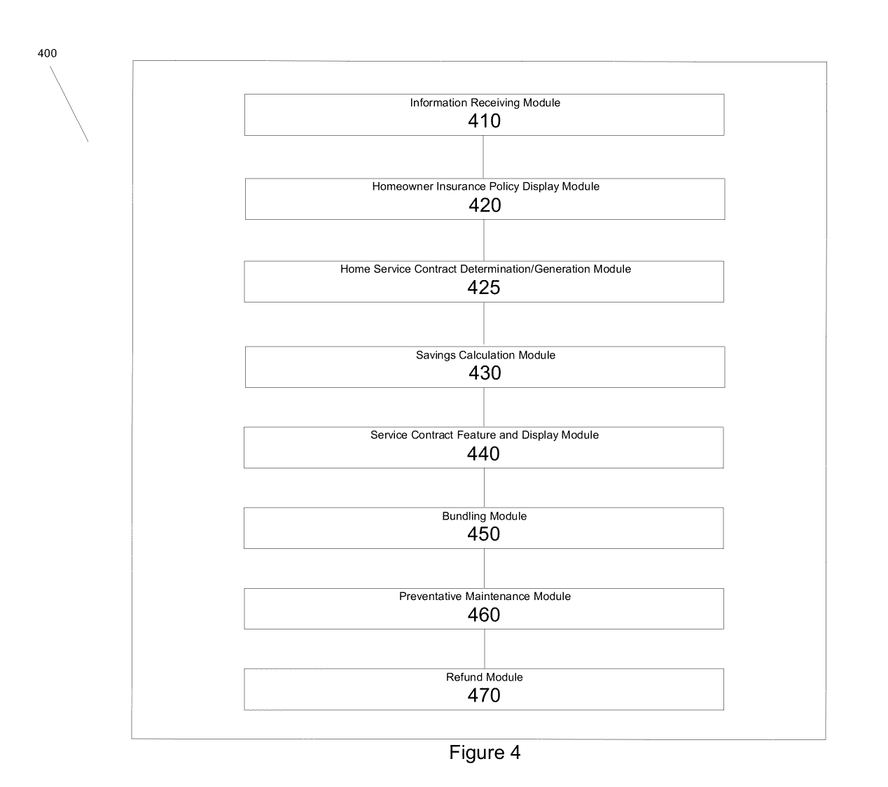

As shown in FIG. 4, some embodiments of the present invention may include a variety of interconnected modules that perform the functions and steps discussed above. In particular, some embodiments may include an information receiving module 410 that receives the property information that is inputted and/or uploaded to the value return system 200 or software package (e.g., by the user). Once the information is received, the information receiving module 410 may transfer the information to a homeowner insurance policy display module 420. The homeowner insurance policy display module 420 may then display a list of the homeowner insurance options (e.g., amount of coverage, deductible, etc.).

After the user selects the homeowner insurance policy they wish to obtain for the property, a home service contract determination module 425 may determine/generate a number of home service contract options as discussed above. Additionally, a savings calculation module 430 may then calculate the insurance premium saving for each of the home service contract options. A service contract display module 440 may then provide the user (e.g., the insurance contract purchaser, homeowner, etc.) with the home service contract options and the insurance premium savings for each. Once the user has selected a home service contract, a bundling module 450 will bundle the selected home service contract with the selected homeowner's insurance policy.

As mentioned above, the homeowner may be billed for the home insurance policy and the home service contract separately or together. In some embodiments, the insurance premium savings may be instantaneous (e.g., upon purchase of the home service contract). However, in other embodiments the homeowner may not obtain the premium savings until the preventative maintenance is performed. To that end, some embodiments may have additional features/modules. For example, some embodiments of the present invention may have an optional preventative maintenance module 460 and an optional refund module 470.

The preventative maintenance module 460 may check the status of the preventative maintenance including whether or not the maintenance has been performed. For example, the system 400 may receive information regarding the maintenance that has been performed under the home service contract. The preventative maintenance module 460 may then determine when and if the homeowner has qualified for the insurance premium rebate. If the homeowner has qualified for the insurance premium rebate, the preventative maintenance module 460 may send the appropriate information (e.g., owner contact information, amount of rebate, etc.) to the rebate module 470, which, in turn, may refund the insurance premium savings to the homeowner (e.g., if the insurance premium has been paid in full) or apply the refund to any outstanding balance on the insurance premium.

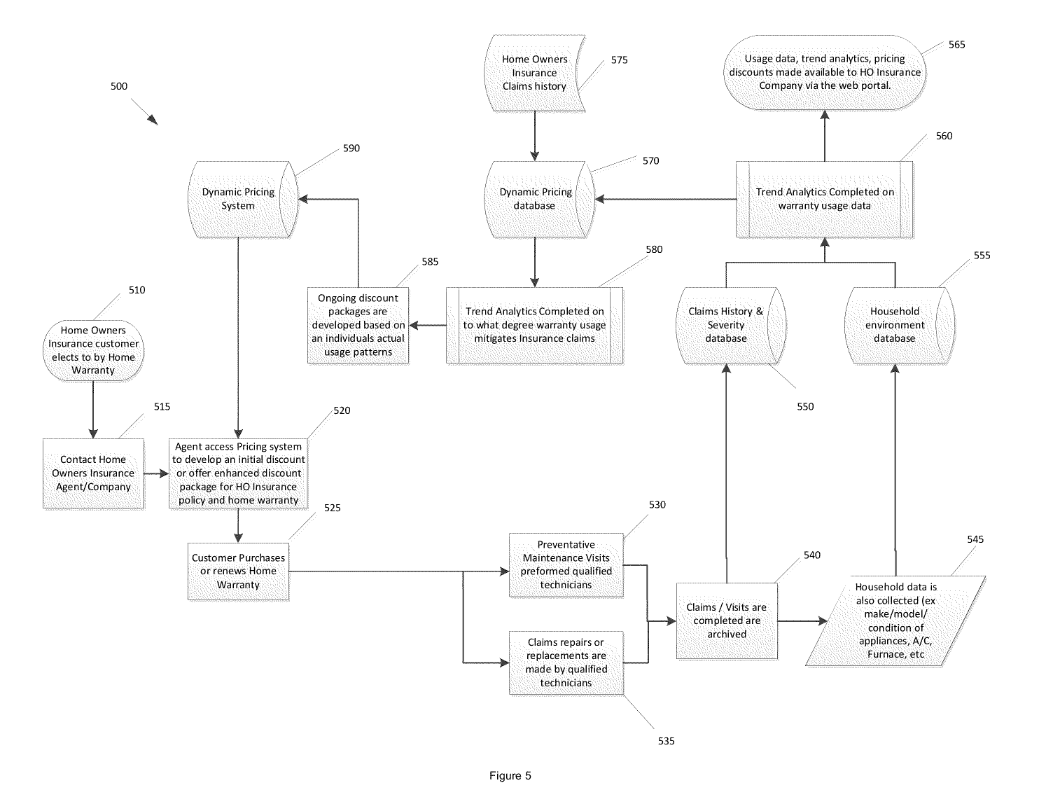

As mentioned above, some embodiments can utilize dynamic pricing to offer additional discounts after the initial purchase of the home owner insurance and home service contract. To that end, FIG. 5 shows a flowchart of one method of bundling homeowner insurance and a home service contract utilizing a dynamic pricing system. It should be noted that, in some embodiments, this dynamic pricing system can be employed at the time the home owner initially purchases the insurance policy or sometime after the home owner has purchased the policy (e.g., when the homeowner purchases the home service contract).

As shown in FIG. 5, once the home owner elects to purchase the home service contract (Step 510), the home service contract provider 230 will contact the home owners insurance agent/company (Step 515) to notify the insurance provider that the home owner has purchased the service contract. The insurance agent may then access the pricing system (e.g., located on the server 250 and via the global communications network 220, see FIG. 2) to develop/access an initial discount (e.g., if the user is purchasing a new insurance contract or is purchasing the home service contract for the first time) or an enhanced discount for the homeowner insurance policy (e.g., if the user has increased the home service contract coverage and/or based upon the data collected during an existing or previous home service warranty term) (Step 520).

After the user has purchased the service contract and the term of the service contract has started (Step 525), the user/home owner may then begin to schedule any preventative maintenance visits provided for in the home service contact (Step 530) and/or make any necessary claims (e.g., for repair and/or replacement) when an appliance and/or other component covered under the service contract fails (Step 535). When the system receives the claim and/or preventative maintenance request, the home service provider 260 can process the claims and/or maintenance request and dispatch a qualified technician (Step 540).

As mentioned above, during the service calls (e.g., to perform the scheduled preventative maintenance, to repair and/or replace broken/faulty components, or otherwise respond to a claim), the service technician can collect and record information/data. For example, if the technician is responding to a claim made by the home owner, the technician can record information/data relating to the claims history of the property (including the claim to which the technician is responding) and the severity of the damage to the failed component and/or the home itself (e.g., caused by the failure of the component). Additionally, when performing preventative maintenance, the technician may collect household data (Step 545) such as, but not limited to, the make, model and condition of the appliances and equipment (e.g., air conditioning units, furnace, water heater, etc.) within the home, the condition of the property itself, whether the home appears to be missing various appliances or components, etc.

Once the technician has completed the service call and/or performed the preventative maintenance, and collected the necessary data, the technician may then input the information/data into one or more databases (e.g., located on the server 250). For example, the technician may utilize a terminal similar to the workstations 210 discussed above, and input the claim history and severity data into a claims database (Step 550), and input the household data into a household environment database (Step 555). As the homeowner makes additional claims and additional preventative maintenance is performed on the property, the databases will begin to grow.

Once the information/data has been entered into the database, the method may then perform a trend analysis on the data (e.g., the warranty usage data including claim data and the household data) (Step 560). For example, the method 500 will analyze the data to determine whether the homeowner is properly maintaining the appliances and equipment, how often preventative maintenance is being performed, whether the homeowner is utilizing all preventative maintenance visits allowed under the home service contract, the age and condition of the appliances and equipment, etc. Based upon this trend analysis, the method is able to determine a level of risk to the homeowner insurance company (e.g., a homeowner that properly maintains their appliances/equipment and/or has new equipment will statistically have a lower risk than those that have old appliances or appliances that are not maintain properly).

It is important to note that, in some embodiments, the method 500 may make the databases, the trend analysis, and any calculated pricing discounts (discussed in greater detail below) available to the homeowner insurance provider 260 (Step 565). For example, the homeowner insurance provider 260 may access a web portal (or the website 240, FIG. 2) which, in turn, allows the insurance provider to access the databases (e.g., located on the server 250, FIG. 2). Similarly, the home owner insurance provider 260 may provide the home service contract provider 230 with information/data relating to any insurance claims made by the homeowner (e.g., an insurance claims history) and/or otherwise provide the home service contract provider access to the data (Step 575). For example, the home owner insurance provider 260 may input the data through the web portal and/or may provide access to the data through its own web portal. The method 500 may then store the insurance claim history (and the results from the trend analysis discussed above) within a dynamic pricing database (Step 570)

Once the initial trend analysis is completed and the system has received the necessary insurance claim history, the method 500 may then perform additional trend analytics to determine the degree to which the warranty usage mitigates insurance claims (Step 580). For example, based upon the insurance claim history data, the warranty claim data, and the household data, the method 500 can determine if the homeowner is more or less likely to experience an incident requiring an insurance claim.

Based upon the above trend analytics (e.g., to determine whether insurance claims are likely to be mitigated), the method 500 may then develop one or more discount packages for the homeowner (Step 585) and store the discount packages within a dynamic pricing system (Step 590). The insurance agent may then, once again, access the pricing system to review the calculated discount packages which may be offered to the homeowner (e.g., at the time of renewal, during the term of the insurance policy, when the homeowner makes a change to an existing insurance policy, etc.).

It is important to note that, because this method (and the systems that utilize this method) tracks and analyzes actual home service contract and homeowner insurance usage data, the discount packages may be developed based upon the actual usage data and patterns of the particular homeowner. Therefore, the discount packages will accurately reflect the behavior and risk level of the individual homeowner. Additionally, the discounts may be recalculated on an ongoing basis as additional data/information is obtained.

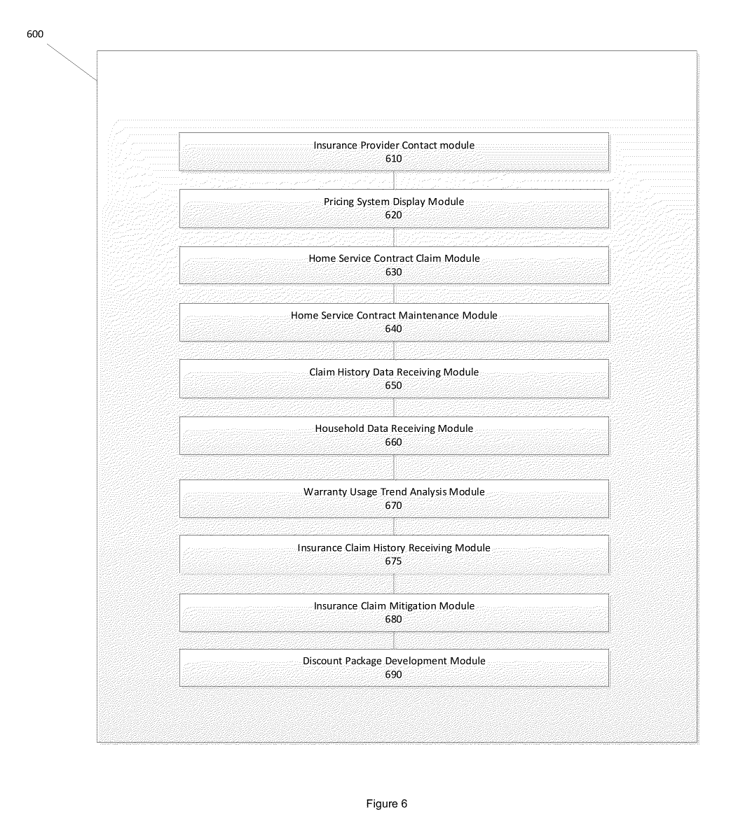

As shown in FIG. 6, some embodiments of the dynamic pricing system/method may include a variety of interconnected modules that perform the functions and steps discussed above. For example, some embodiments of the system 600 may include an insurance provider contact module 610 that contacts the insurance provider (e.g., by sending a message to the insurance provider) when the homeowner elects to purchase a home service contract. When the insurance provider accesses the dynamic pricing system (e.g., via the website or web portal), a pricing system display module 620 displays the discount options (e.g., the initial discounts) that may be offered to the homeowner.

Once the homeowner has purchased the home service contract and the contract term has started, the home service contract claim module 630 may receive any claims made by the homeowner, and may schedule and/or dispatch an appropriate technician. Similarly, the home service contract maintenance module 650 can receive requests for preventative maintenance visits and dispatch/schedule an appropriate technician to perform the requested service.

As mentioned above, during the claim repair and maintenance visits, the technician can collect various data regarding the repair/visit and the condition of the home/appliances, and input that data into the system. To that end, some embodiments can also include a claim history data receiving module 650 that receives the claims data and stores the data within the claim history database. Similarly, the system 600 can also include a household data receiving module 660 that receives the household data and stores the data within the household environment database.

Once the appropriate data has been collected and stored in the databases, a warranty usage trend analysis module 670 may perform the trend analysis on the data. For example, as mentioned above, the trend analysis module 670 may analyze the data to determine whether the homeowner is properly maintaining the appliances and equipment, how often preventative maintenance is being performed, whether the homeowner is utilizing all preventative maintenance visits allowed under the home service contract, the age and condition of the appliances and equipment, etc. Based upon this trend analysis, the warranty usage trend analysis module 670 is able to determine a level of risk to the insurance provider (e.g., a homeowner that properly maintains their appliances/equipment and/or has new equipment will statistically have a lower risk than those that have old appliances or appliances that are not maintain properly). Additionally, the warranty usage trend analysis module 670 may also make the usage data and trend analytics available to the insurance provider, and store the information within the dynamic pricing database.

The system 600 may also include an insurance claim history receiving module 675 that receives the insurance claim history from the insurance provider, and stores the insurance claim history within the pricing database. An insurance claim mitigation module 680 may then access the insurance claim history and the warranty usage trend analysis information (e.g., within the pricing database) and perform additional trend analytics to determine the degree to which the warranty usage will mitigate future insurance claims. The insurance claim mitigation module 680 can also forward the claim mitigation analysis information to a discount package develop module 690 that, in turn, calculates and determines at least one discount package that may be offered to the homeowner. The insurance provider can access these this discount packages via the pricing system display module 620 discussed above.

It is important to note that embodiments of the present invention may be implemented in whole or in part in any conventional computer programming language. For example, preferred embodiments may be implemented in a procedural programming language (e.g., “C”) or an object oriented programming language (e.g., “C++”, Python). Alternative embodiments of the invention may be implemented as pre-programmed hardware elements, other related components, or as a combination of hardware and software components.

For example, a pseudo code representation of a generic embodiment might be set forth as follows:

```
provide homeowner with insurance policy on property;
    determine home service contract options
    calculate homeowner insurance premium savings for each home
    service contract option
    provide homeowner with home service contract options for purchase
    check status of the home service contract
        if home service contract purchased
            then bundle homeowner insurance policy and home
            service contract.
```

In accordance with other embodiments, the invention may be implemented as a computer program product for use with a computer system, such as the workstations 210 shown in FIG. 2. Such implementation may include a series of computer instructions fixed either on a tangible medium, such as a computer readable media (e.g., a diskette, CD-ROM, ROM, or fixed disk), or transmittable to a computer system via a modem or other interface device, such as a communications adapter connected to a network over a medium. The medium may either be a tangible medium (e.g., optical or analog communications lines) or a medium implemented with wireless techniques (e.g., microwave, infrared or other transmission techniques). The series of computer instructions embodies all or part of the functionality previously described herein with respect to the system. For example, the series of computer instructions may be a computer program that may be installed on one or more of the workstations 210. The installed program may then perform the functions described above. For example, the software program may present the user with a graphical interface and a series of templates to facilitate the necessary data input and selection of insurance policies and home service contract options. The software program or home service contract provider may then bundle the insurance policy and home service contract and provide the user/owner with the rebate on the insurance premium.

Those skilled in the art should appreciate that such computer instructions/software programs can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable media with accompanying printed or electronic documentation (e.g., shrink wrapped software), preloaded with a computer systems (e.g., on system ROM or fixed disk), or distributed from a server or electronic bulletin board over the network (e.g., the Internet or World Wide Web). Additionally or alternatively, the instructions may be stored within a memory located within the workstations 210 or the server 250 and may be executable by one or more processors located within the workstation 210 of server 250.

What is claimed is:

1. A system for bundling homeowner insurance and a home service contract comprising:
a processor; and
a memory storing instructions executable by the processor to perform processes that include:
providing, to a homeowner, a homeowner insurance policy on at least one property owned by the homeowner;
determining at least one home service contract based upon the at least one property owned by the homeowner;
calculating an insurance premium savings for each of the at least one home service contracts;
offering the at least one home service contract to the homeowner; and
bundling, if the homeowner purchases one of the at least one home service contacts, the homeowner insurance policy with the purchased home service contract, the home service contract including preventative maintenance on one or more high risk home items.

2. A system according to claim 1, wherein the preventative maintenance on the one or more high risk home item reduces the risk of damage to the home, thereby reducing insurance claims.

3. A system according to claim 2, wherein the insurance premium savings is based, at least in part, upon the reduction in the risk of insurance claims.

4. A system according to claim 1, wherein the preventative maintenance includes at least one of replacing water hoses on a clothes washer and cleaning a vent on a clothes dryer.

5. A system according to claim 4, wherein the water hoses are replaced with stainless steel water hoses.

6. A system according to claims 1, wherein the home service contract does not cover at least one of missing appliances, missing home systems, rust and corrosion, and abuse to the property.

7. A system according to claim 6, wherein abuse includes intentional or neglectful damage to at least one air conditioning systems, heating systems, kitchen appliances, and laundry appliances.

8. A system according to claim 1, wherein the home service contract is a multi-year service contract.

9. A system according to claim 1, wherein bundling includes applying the insurance premium savings for the home service contract purchased by the homeowner to a cost of the insurance.

10. A computer implemented method for bundling homeowner insurance and a home service contract comprising:
providing, using a computer, a homeowner insurance policy on at least one property owned by a homeowner;
determining, using a computer, at least one home service contract based upon the at least one property owned by the homeowner, the home service contract including at least one preventative maintenance service on the property;
calculating, using a computer, an insurance premium savings for each of the at least one home service contracts;
providing, using a computer, the homeowner with an opportunity to purchase at least one of the home service contracts; and
bundling, using a computer, the homeowner insurance policy with the home service contract purchased by the homeowner.

11. A computer implemented method according to claim 10, wherein the at least one preventative maintenance service is performed on one or more high risk home items, the at least one preventative maintenance service reducing the risk of damage to the home.

12. A computer implemented method according to claim 11, wherein reducing the risk of damage to the home reduces the risk of insurance claims by the homeowner.

13. A computer implemented method according to claim 12, wherein the insurance premium savings is based, at least in part, on the reduction in the risk of insurance claims.

14. A computer implemented method according to claim 10, wherein the at least one preventative maintenance service includes at least one of replacing water hoses on a clothes washer and cleaning a vent on a clothes dryer.

15. A computer implemented method according to claim 14, wherein the water hoses are replaced with stainless steel water hoses.

16. A computer implemented method according to claims 10, wherein the home service contract does not cover at least one of missing appliances, missing home systems, rust and corrosion, and abuse to the at least one property.

17. A computer implemented method according to claim 16, wherein abuse includes intentional or neglectful damage to at least one air conditioning systems, heating systems, kitchen appliances, and laundry appliances.

18. A computer implemented method according to claim 10, wherein the home service contract is a multi-year service contract.

19. A computer implemented method according to claim 10, wherein bundling includes applying the insurance premium savings for the home service contract purchased by the homeowner to a cost of the insurance policy.

20. A system for bundling homeowner insurance and a home service contract comprising:
means for providing a homeowner insurance policy on at least one property owned by a homeowner;
means for determining at least one home service contract based upon the at least one property owned by the homeowner, the home service contract including at least one preventative maintenance service on the property;
means for calculating an insurance premium savings for each of the at least one home service contracts;
means for providing the homeowner with an opportunity to purchase at least one of the home service contracts; and
means for bundling the homeowner insurance policy with the home service contract purchased by the homeowner.

21. A system according to claim 20, wherein the at least one preventative maintenance service is performed on one or more high risk home items, the at least one preventative maintenance service reducing the risk of damage to the home.

22. A system according to claim 21, wherein reducing the risk of damage to the home reduces the risk of insurance claims by the homeowner.

23. A system according to claim 22, wherein the insurance premium savings is based, at least in part, upon the reduction in the risk of insurance claims.

24. A system according to claim 20, wherein the at least one preventative maintenance service includes at least one of replacing water hoses on a clothes washer and cleaning a vent on a clothes dryer.

25. A system according to claim 24, wherein the water hoses are replaced with stainless steel water hoses.

26. A system according to claims 20, wherein the home service contract does not cover at least one of missing appliances, missing home systems, rust and corrosion, and abuse to the property.

27. A system according to claim 26, wherein abuse includes intentional or neglectful damage to at least one air conditioning systems, heating systems, kitchen appliances, and laundry appliances.

28. A system according to claim 20, wherein the home service contract is a multi-year service contract.

29. A system according to claim 20, wherein the means for bundling applies the insurance premium savings for the home service contract purchased by the homeowner to a cost of the insurance policy.

30. A system for calculating discounts for an insurance policy bundled with a home service contract comprising:
a processor; and
a memory storing instructions executable by the processor to perform processes that include:
providing, to a home owner, a home service contract for at least one property owned by the home owner, the home service contract including preventative maintenance on one or more home items;
notifying an insurance provider that the home owner has purchased the home service contract;
calculating an initial insurance premium discount package based upon the home service contract purchased by the home owner;
providing the insurance company access to a dynamic pricing system, the dynamic pricing system including the initial insurance premium discount package for a homeowner insurance policy, thereby allowing the insurance provider to provide an initial insurance premium discount to the homeowner.

31. A system according to claim 30, the memory storing further instructions executable by the processor to perform processes that include:
receiving service contract claims data, the service contract claims data including data relating to home service contract claims made by the homeowner;
storing the service contract claims data within a claims history database;
receiving household data, the household data including data relating to a plurality of items within the home; and
storing the household data within a household environment database.

32. A system according to claim 31, the memory storing further instructions executable by the processor to perform processes that include:
performing a first trend analysis on the claims data and household data to determine a risk level to the insurance provider.

33. A system according to claim 32, the memory storing further instructions executable by the processor to perform processes that include:
receiving insurance claim data from the insurance provider;
storing the insurance claim data within a pricing database;
performing a second trend analysis on the insurance claim data, service contract claims data, and household data to determine a level of insurance claim mitigation for the homeowner;
developing an enhanced insurance premium discount package based upon the level of insurance claim mitigation; and
providing the insurance company access to the dynamic pricing system, the dynamic pricing system including the enhanced insurance premium discount package, thereby allowing the insurance provider to provide an enhanced insurance premium discount to the home owner.

34. A system according to claim 32, the memory storing further instructions executable by the processor to perform processes that includes:
providing the insurance company access to the service contract claims data, the household data, and the first and second trend analysis.
